(19) United States
(12) Patent Application Publication
(10) Pub. No.: US 2016/0232499 A1
(43) Pub. Date: Aug. 11, 2016

(54) SECURE PAYMENT FOR LAUNDRY MACHINES

(71) Applicant: Clear Token Inc., Denver, CO (US)

(72) Inventors: Lawrence Berman, Delray Beach, FL (US); Stanley J. Wolfson, Denver, CO (US)

(21) Appl. No.: 15/099,508

(22) Filed: Apr. 14, 2016

Related U.S. Application Data
(63) Continuation-in-part of application No. 14/709,001, filed on May 11, 2015.
(60) Provisional application No. 61/992,260, filed on May 13, 2014.

(51) Int. Cl. G06Q 20/02; G06Q 20/18; G06Q 20/40; G06Q 20/36; G06Q 20/04

(52) U.S. Cl. CPC G06Q 20/02; G06Q 20/3674; G06Q 20/0457; G06Q 20/401; G06Q 20/18; G06Q 2220/00

(57) ABSTRACT

A secure payment system and method for operating a laundry machine are disclosed. In an example, the secure payment system includes a remote payment processor to confirm payment by a customer for a transaction at a laundry machine, and to issue a token to the customer for the transaction. The token has a transaction index and a transaction code to operate the laundry machine. The system also includes an interface module for the laundry machine configured to receive the token from the customer for the transaction. The system also includes a token handler having a token processing module to confirm validity of the token based on the transaction index and the transaction code of the token. The token handler issues a signal to actuate control electronics of the laundry machine in response to a valid token.

### RELATED APPLICATIONS AND PRIORITY CLAIM

This application is a continuation-in-part (CIP) patent application of U.S. patent application Ser. No. 14/709,001 titled “Secure Payment System and Method” of Stanley J. Wolfson, filed on May 11, 2015, which claims the priority benefit of U.S. Provisional Patent Application No. 61/992,260 titled “Secure payment system” of Stanley J. Wolfson, filed on May 13, 2014, and is also related to U.S. Provisional Patent Application No. 61/951,875 titled “Secure payment system” of Stanley J. Wolfson, filed on Mar. 12, 2014 and corresponding U.S. patent application Ser. No. 14/645,196 filed on Mar. 11, 2015, and U.S. patent application Ser. No. 14/671,456 titled “Parking Meter Payment Device” of Berman, et al. filed on Mar. 27, 2015, each of which is hereby incorporated by reference for all that is disclosed as though fully set forth herein.

### BACKGROUND

Increasingly, our global society is moving towards a culture in which transactions, whether social or business in nature, take place electronically via wireless devices including for example, mobile phones, tablets, computers and other electronic devices through connection to the Internet or wireless provider network (e.g., 3G, 4G networks). While these transactions can be easily implemented in an online storefront, and even in a physical store by having a store clerk available to assist customers and/or reduce the occurrence of fraud (e.g., data processing and so-called “skimming” of credit card information), some purchases may lack such a facilitator, for example at a laundry facility. Use of laundry facilities (or “laundromats”) often requires the user to have coins, credit cards, prepaid cards, and/or dollar bills available.

### BRIEF DESCRIPTION OF THE DRAWINGS

FIG. 1A is an illustration of an example secure payment system implemented by a laundry machine.

FIG. 1B is a block diagram of an example secure payment system for a laundry machine.

FIG. 2A is a high-level diagram of a token provider of the secure payment system for a laundry machine.

FIG. 2B is a diagram of a token handler of the secure payment system for a laundry machine.

FIG. 2C is another diagram of a token handler of the secure payment system for a laundry machine.

FIG. 3 illustrates example communication and commands which may be implemented by the secure payment system for a laundry machine.

FIG. 4 illustrates an example coding scheme to build a token.

FIG. 5 illustrates an example coding scheme to validate a token and process a transaction at a laundry machine.

FIG. 6 is a flow chart illustrating example operations which may implement a secure payment method at a laundry machine.

FIG. 7 is a flow chart illustrating example operations of a token provider to implement a secure payment method at a laundry machine.

FIG. 8 is a flow chart illustrating example operations to implement a secure payment method at a laundry machine.

### DETAILED DESCRIPTION

A secure payment system for laundry facility equipment is disclosed which may be implemented to pay for use of a laundry machine (e.g., washer, dryer, soap dispenser, or other laundry facility equipment) using an electronic device such as, but not limited to, a mobile phone, without needing to have a physical credit card or traditional cash on hand. In an example, a user (e.g., a customer) may issue a request for a transaction for a laundry machine at the laundry facility. The request is processed to confirm payment, and a token (e.g., a secure digital certificate such as an electronic data file) is issued to the customer.

The customer may then transmit (e.g., wirelessly transmit) the token to a token handler for a laundry machine. In an example, the token handler is provided on (or as an integral part of) an individual laundry machine (e.g., a clothes washer or clothes dryer). In another example, the token handler is provided in the laundry facility remote from the individual laundry machines, and the token handler is interconnected (wired or wirelessly) to the Individual laundry machines to actuate operation of a selected laundry machine. The token handler validates the token and negotiates the transaction (e.g., actuate operation of the selected laundry machine).

An example token handler includes a wireless certificate reader configured to receive a digital certificate or “token” from a mobile computing device. In use, a mobile computing device (e.g., mobile phone) may include an installed application or “app”. When the mobile computing device is activated via the app, it searches for any token handlers in the area (e.g., a laundry facility) which may be operated with the digital payment system. In an example, the app may display a list of token handlers in the user's vicinity which accept payment via the secure payment system. In other examples, the customer may manually identify the token handler (e.g., by entering an ID for a laundry machine and/or laundry facility in the app).

It is noted that the wireless certificate reader does not need to establish a connection to the payment provider or other entity. As such, the token handler does not need to be configured with an expensive to install and maintain modem or other communications system. The wireless certificate reader can instead be a BLUETOOTH™ or other near-field communication protocol for communicating with the mobile computing device in proximity to the token handler.

In addition, the laundry machine and/or laundry facility does not need to be in an area having mobile phone/data service. For example, the user may request a token at their home, and then use that token at a laundry machine or laundry facility that is out of a service area by providing it to the token handler for the laundry machine via the BLUETOOTH™ or other near-field communication protocol.

In an example, data to validate the token received at the token handler is stored in the local memory of the token handler before a transaction is initiated at the token handler. As such, no communication connection is required between the digital payment system and the third party payment system. This enables use of the digital payment system without having to provide expensive communication connections in each laundry facility and/or laundry machine.

The token may be a one-time-use digital certificate. In an example, after the token has been confirmed and the transaction negotiated (i.e., the laundry machine has been actuated), the corresponding information stored in the token handler may be “wiped” clean (e.g., the code set to zero or otherwise erased). This helps ensure that the goods and/or services delivered by the token handler have been paid for and that the same digital certificate is not being re-used. In another example, the token may include an expiration, so that a customer cannot purchase tokens in advance to avoid price increases.

In an example, the secure payment system may operate with a third-party payment processor to handle payments for the user without the user having to provide any credit card or other form of payment (or personal or other information) at the laundry machine (or the owner or anyone operating the laundry facility). For example, the user may have already provided payment information (e.g., credit card or bank account information) to the third-party payment processor, who is a trusted payment processor such as the user's bank, credit card issuer, direct carrier billing (e.g., billing to a cell phone account), digital currency, or other payment service, and therefore the user does not have to provide any payment information to the token handler or the token provider. As such, the secure payment system reduces the opportunity for fraud, while providing the user with the convenience of a so-called “cashless” transaction. Likewise, the owner of the laundry machine or laundry facility receives payment from a trusted third-party payment processor without risk that the payment form (e.g., credit card) is stolen or unauthorized.

It is noted that the systems and methods described herein are not limited to any particular type of laundry facility, laundry machine, mobile device, and/or payment processor. The digital payment system may be used in an attended and/or unattended environment, and may be used to enable operation of any type of laundry machine and/or to provide product (e.g., detergent, softener, etc.).

Before continuing, it is noted that as used herein, the terms “includes” and “including” mean, but is not limited to, “includes” or “including” and “includes at least” or “including at least.” The term “based on” means “based on” and “based at least in part on.”

It is also noted that the term “token” as it refers to a type of “digital certificate” (or “electronic information” or “data packet”) is intended to broadly designate electronic data or information provided by the system to a mobile device, which may or may not be further processed by the mobile device, and which is capable of being processed in conjunction with data or information provided for a laundry machine at the laundry facility to verify or otherwise confirm payment.

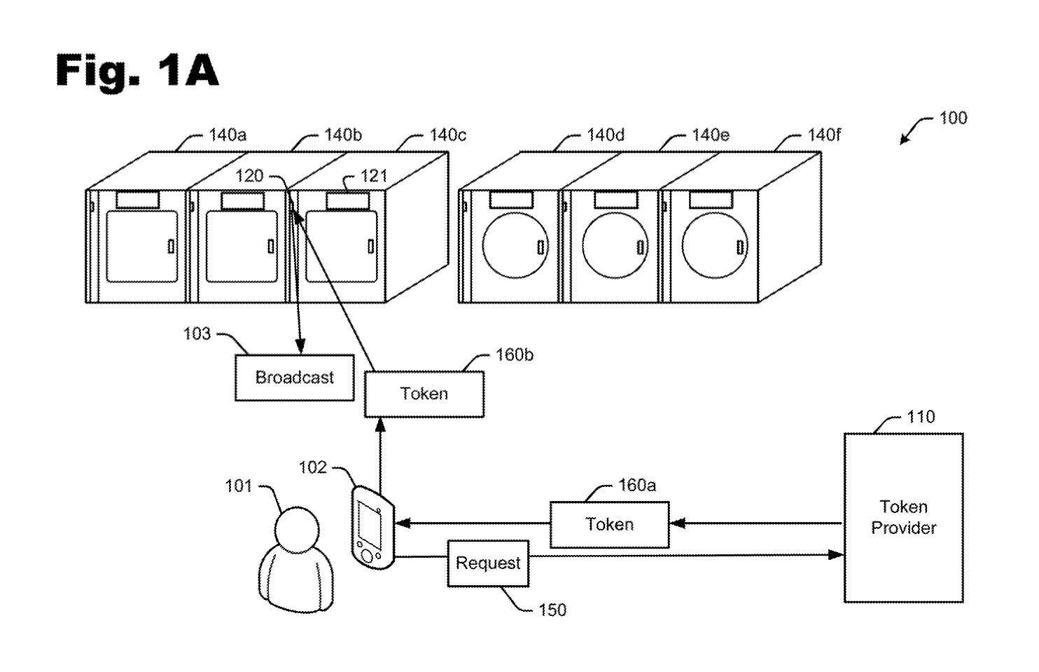

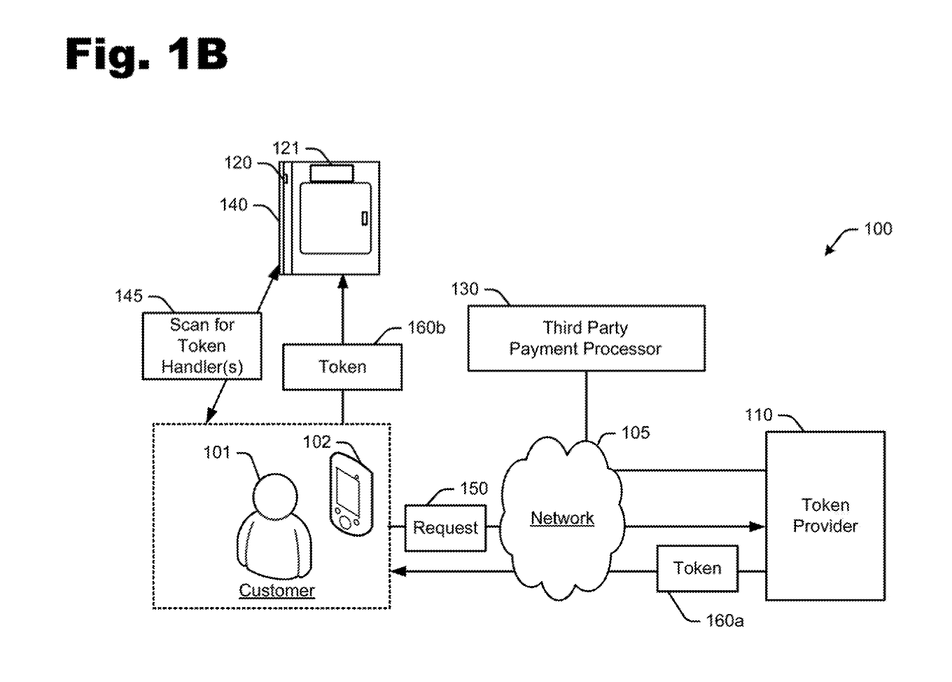

FIG. 1A is an illustration of an example secure payment system 100 as it may be implemented for a laundry machine. FIG. 1B is a block diagram of an example secure payment system 100. System 100 may be implemented with any of a wide variety of computing devices. Each of the computing devices may include memory, storage, and a degree of data processing capability at least sufficient to manage a communications connection either directly with one another or indirectly (e.g., via a network). At least one of the computing devices is also configured with sufficient processing capability to execute program code and/or other logic described herein.

In an example, the secure payment system 100 may be implemented by a token provider 110 providing a digital payment service accessed by a user 101 via a client device 102 (referred to herein collectively as the “customer”). The client device 102 may be any suitable computer or computing device (e.g., laptop computer or other mobile device such as a phone or tablet) capable of accessing a third party payment processor 130.

Of course, the token provider 110 and client device 102 are not limited to any particular type of devices (e.g., watches and other wearable technology), and may also include other devices that are traditionally not considered to be a part of the mobile environment (e.g., desktop computing devices or terminals).

In an example, the secure payment system 100 may be implemented with one or more communication network 105, such as a local area network (LAN) and/or wide area network (WAN) and/or other communications platform such as a mobile communications network. In an example, the network includes the Internet and/or other mobile communications network (e.g., a 3G or 4G mobile device network).

In an example, the secure payment system 100 provides a way for the user 101 to pay to use laundry machine(s) 140a-f (referred to generally herein as laundry machine 140), using the user's own mobile device 102, via the digital payment service implemented by the token provider 110, but without having to provide payment at the laundry machine 140 because access to payment information is maintained by third party payment processor(s) 130 (e.g., a bank or credit card company).

In use, a mobile device 102 (e.g., a mobile phone) may include an installed application or “app”. When the mobile device 102 is activated via the app, the mobile device 102 searches 145 for any laundry machines 140 in the area which are configured for operation in the environment of the secure payment system 100. In an example, the laundry machine(s) 140 may broadcast 103 its presence. The mobile device 102 within range of the broadcast enables the app may display a list on the mobile device 102 of laundry machines in the user's vicinity which are configured to accept payment via the payment technique described herein. In another example, the laundry machines 140 may be pre-stored in a database accessed by the app via the Internet.

In an example, the user may issue a request 150 to the token provider 110. The request 150 may include the laundry machine ID (e.g., a number shown on the laundry machine) or other identifying information. The request 150 may also include other information about the intended purchase (e.g., laundry machine location and time of use) and a payment authorization. For example, the amount of payment may be displayed for the user by the app for the user to accept or approve the item and amount. The user may then select a third party payment processor 130 (e.g., a bank, credit card, or mobile phone service carrier) from the app. This information may be transmitted in the request 150 to the token provider.

The token provider 110 then confirms payment via the third party payment processor 130. For example, the token provider 110 may issue a payment authorization to a third-party payment processor 130, and receive payment approval from the third-party payment processor. After confirming payment, the token provider 110 may generate a token 160a and issue the token 160 to the user's mobile device 102.

After receiving the token 160a, the user may then complete the transaction by the token handler 120 at the laundry machine 140. In an example, the laundry machine 140 is configured with a token handler 120 operatively associated with a control board 121 on the laundry machine 140 (e.g., configured to select a wash or dry cycle and/or other functions at the laundry machine 140). The token handler 120 may have a wireless certificate reader configured to receive a token 160b from the mobile device 102. The token 160a and 160b may be the same token provided by the token provider 110, or token 160b may undergo at least some degree of processing at the mobile device 102 before being issued to the token handler 120 at the laundry machine 140.

The token handler 120 at the laundry machine 140 may then process the token 160b to confirm payment by the user 101. If payment is confirmed, then the token handler 120 at the laundry machine 140 may negotiate the transaction (e.g., starting or continuing operation of the laundry machine).

As such, the system 100 provides a way for the user 101 to pay for use of the laundry machine 140, using the user's own mobile device 102, but without having to provide direct access to payment details because those are maintained by third party payment processor(s) 150 (e.g., a bank or credit card company).

In an example, various operations of the secure payment system 100 may be implemented at least in part by program code and/or logic circuitry. Program code and/or logic used to implement features of the system can be better understood with reference to the following discussion and various example functions. To the extent program code is implemented, machine-readable instructions may be stored on a non-transient computer readable medium and are executable by one or more processor to perform the operations described herein. Examples of program code may include an end-user mobile device application (or “app”), payment processing application(s), host application (e.g., for generating the token in response to receiving confirmation of payment), and/or a token handling application (e.g., for validating the token received from the end-user device and actuating a laundry machine). Of course, the operations described herein are not limited to any specific implementation with any particular type of program code or logic.

It is noted, however, that the secure payment system 100 is not strictly data handling or program code for manipulating data in the traditional sense. That is, the secure payment system 100 may be implemented at least in part in program code (e.g., for generating the token and for various of the transmission protocols). It is to be understood that the secure payment system 100 is also implemented by device hardware which goes beyond a mere computing device provided to execute the program code. Example device hardware may include a wireless certificate reader with a communications interface (e.g., to the mobile device). Example device hardware may also include electronic actuators, motors, timers, and/or other electronics which operate the laundry machine 140 in response to input from the wireless certificate reader and/or other processing device confirming payment.

These and other aspects of the secure payment system 100 will be described in more detail below such that the device hardware can be readily implemented by one having ordinary skill in the art after becoming familiar with the teachings herein.

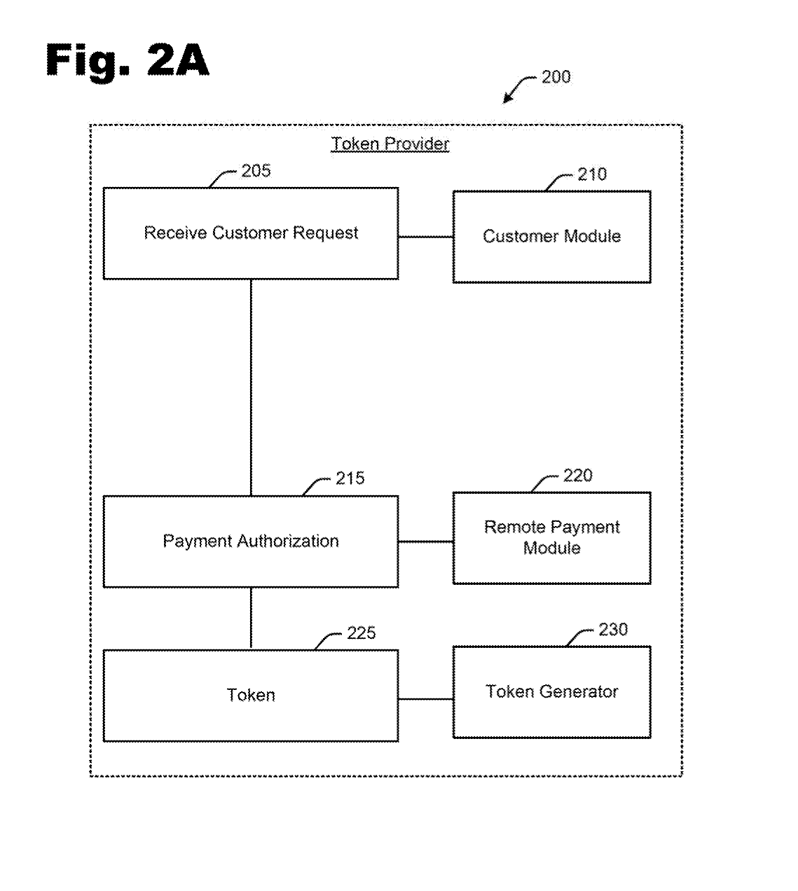

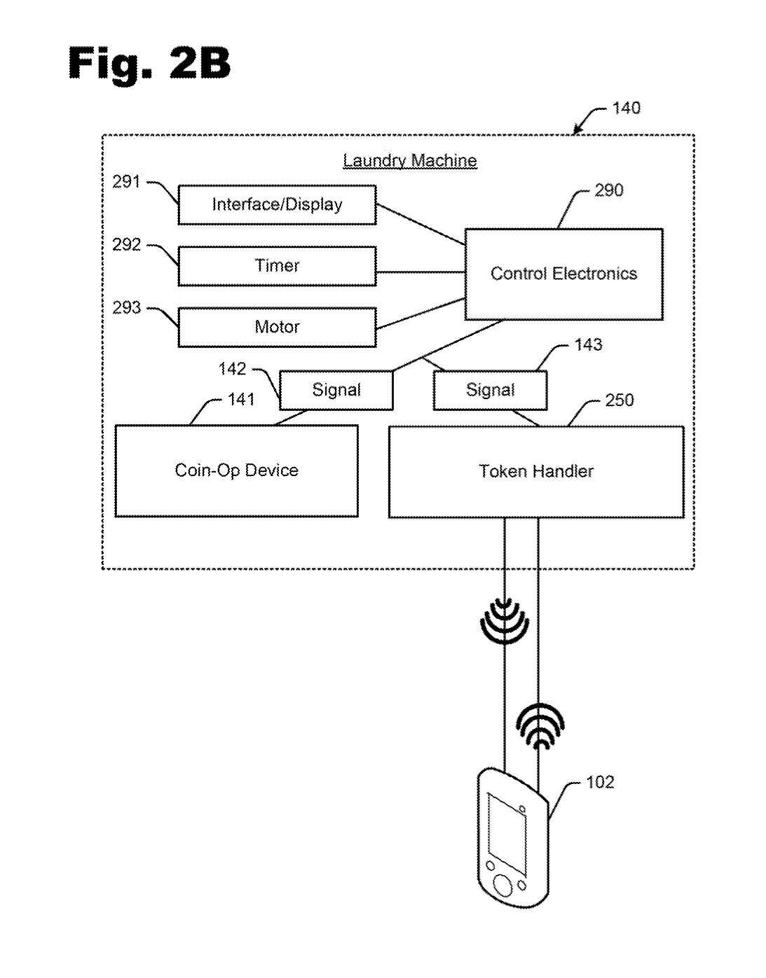

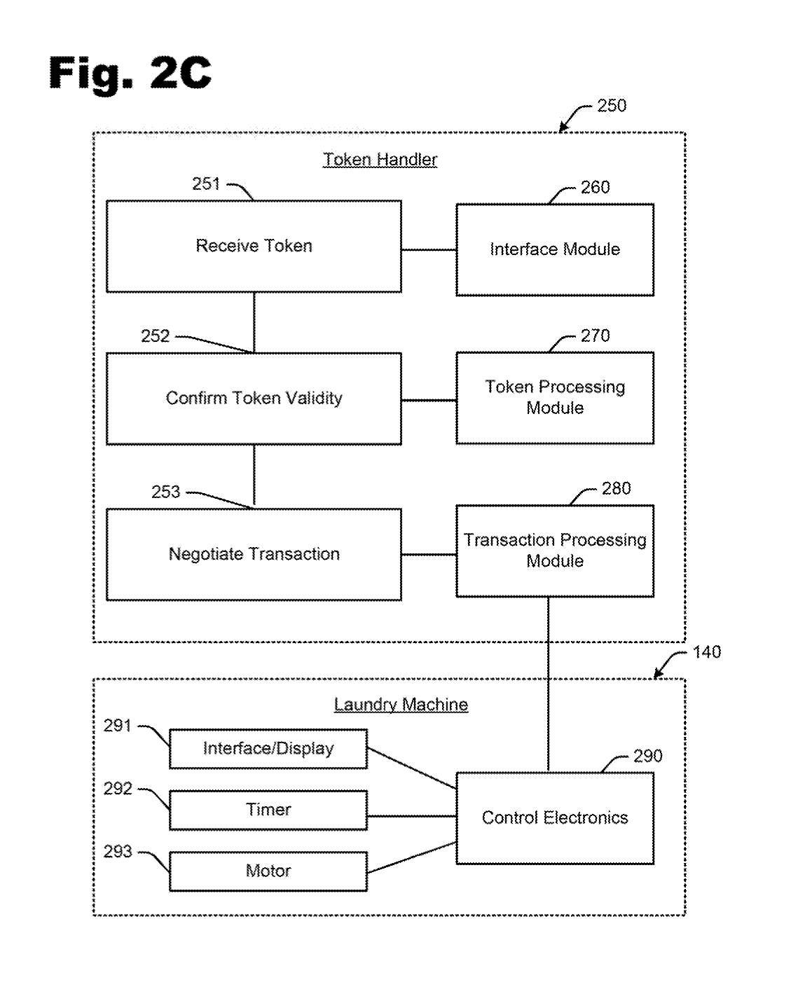

FIG. 2A is a high-level diagram of a token provider 200 (e.g., token provider 110 in FIG. 1B) of the secure payment system. The token provider 200 may receive a request 205 for a transaction (e.g., including a payment amount) at a token handler 120 at the laundry machine 140 via a customer module 210. In an example, the request 205 may include information about the laundry machine 140 (e.g., identifying information). The token provider 200 issues a payment authorization 215 via a remote payment module 220 to a third-party payment processor. It is noted that the token provider 200 does not actually receive any payment or other personal or confidential payment information from the customer. This information remains confidential as between the customer and the third party payment processor (e.g., the customer's bank or credit card processor). The token provider 200 receives payment approval from the third-party payment processor. The token provider 200 includes a token generator 230 to generate a token 225 and issues the token 225 to the customer so that the customer can complete the transaction at the token handler device configured for operating the laundry machine.

FIG. 2B is a diagram of a token handler device 250 of the secure payment system for a laundry machine (e.g., token handler 120 for the laundry machine 140 in FIGS. 1A and 18B). FIG. 2B illustrates an example where a laundry machine 140 having an existing coin-operated interface is retrofitted with the token handler device 250 disclosed herein. In an example, retrofitting the token handler device 250 may enable operation of the laundry machine 140 by either the existing coin-operated interface 141 and/or via the token handler device 250. For example, the token handler 250 may be wired between the coin-op device 141 and the control electronics 290. In an example, the token handler 250 is connected between the coin-op device 141 and the control electronics 290 without having to cut the existing wiring, e.g., by a coupler that splices through the wire insulation to make an electrical connection with the wiring by press-fit without having to cut the wires. It is noted, however, that the laundry machine 140 does not need to be retrofitted with the token handler device 250, and the laundry machine 140 can also be configured from the start with the token handler device 250.

In an example, the coin-op device 141 generates an electrical signal 142 or pulse in response to receiving coins. For example, each quarter may generate an electrical pulse thereby indicating a total dollar amount at the control electronics 290. For example, each time a user inserts a quarter, an electrical pulse is issued to the control electronics and the total dollar amount entered is displayed for the user (e.g., $0.25, $0.50, etc.) until the dollar amount is displayed for the desired function (e.g., $1.25 for a light duty wash cycle or $2.25 for a heavy duty wash cycle).

In an example, the token handler 250 is configured to generate an electrical pulse for each token received by the token handler, or multiple electrical pulses for the total dollar value of the token. For example, the token handler 250 may generate individual electrical pulses for each $0.25 token received. Or if a token is received having a value of $1.25, the token handler 250 may generate five electrical pulses to inform the control electronics 290 of the dollar value received. The laundry machine 140 can then be operated similarly to the user inserting coins in the coin-op device 141.

FIG. 2C is another diagram of a token handler device 250 of the secure payment system for a laundry machine (e.g., token handler 120 for the laundry machine 140 in FIGS. 1A and 1B). Although shown as separate entities in FIG. 2C, as already noted above the token handler 250 may be mounted in or otherwise provided at the laundry machine 140; or the token handler 250 may be provided at physically remote location from the laundry machine 140.

In an example operation, the token handler device 250 receives a token 251 from the customer (e.g., the token 225 issued to the customer by the token provider 200 in FIG. 2A) via an interface module 260. The token handler device 250 may receive the token 251 from the customer's mobile device via a BLUETOOTH™ or other near-field communication protocol. A token processing module 270 compares data value(s) of the token to data value(s) stored at the token handler device 250. For example, the token processing module 270 may translate the hex value to determine the transaction code and the transaction index, and then compare these to the corresponding device code stored at the associated index location.

The token handler device 250 confirms that the token is valid at 252. If the token is valid, a transaction processing module 280 may negotiate the transaction 253 for the laundry machine. In an example, the transaction processing module 280 may actuate control electronics 290 of a laundry machine 140, for example by issuing a signal to the control electronics 290. The control electronics 290 may include a computer board on the laundry machine 140 which in turn actuates the laundry machine, such as an interface or display 291 on the laundry machine (e.g., to start/stop or select a wash cycle on the laundry machine), a timer (e.g., to set or add a time of operation of the laundry machine), a motor (e.g., to drive the clothes tumbler). Other components and/or functions can also be controlled by actuating via the token handler device 250, such as but not limited to different cycles (e.g., heavy duty, rinse, spin, etc.).

It is noted that the term “module” as used herein means electronic devices (e.g., logic circuitry) and/or machine readable instructions (e.g., firmware) specifically configured to carry out the operations described herein.

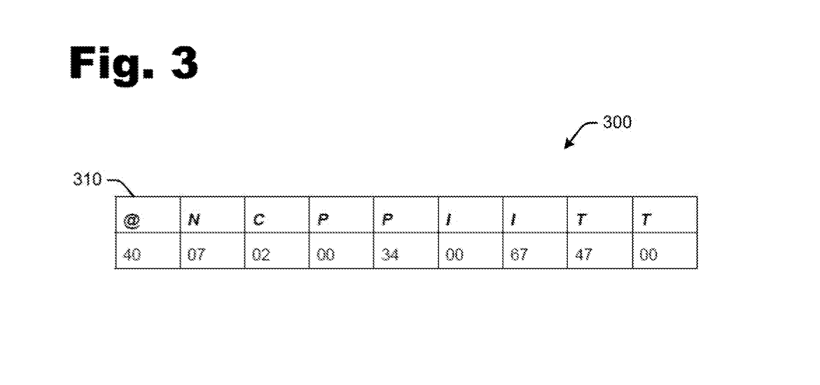

FIG. 3 illustrates example communication and commands 300 which may be implemented by the secure payment system. First, a communications connection may be established. According to the BLUETOOTH™ protocol (e.g., BLUETOOTH™ LE or “BLE,” BLUETOOTH™ 4.0, and BLUETOOTH™ Smart), the token handler has a role of a server or peripheral device, and the user's mobile device has a role of a client or central device.

The token handler advertises its presence (e.g., every 1.00 to 1.25 seconds). The mobile devices scans for nearby token handlers at an interval that is less (e.g., faster) than the advertise interval. In an example, the scan interval and window can be configured with the mobile device. The mobile device may have two methods of scanning for devices (e.g., scan for all devices, or scan only for devices offering a specific service). The latter example is by scanning for a specific UUID that represents a service. By way of illustration, the token handler is represented by the following UUID: c9cab9b8-3abf-4043-a5af-9ad00c6074d5.

After executing the Generic Access Protocol (GAP) to find a device, the Generic Attribute Profile (GATT) can be executed for “service discovery” to find the supported “characteristics” for each service. Each characteristic has an associated UUID and handle, and can be read or written. In an example, UUID's have two lengths (e.g., 16-bit UUID is a standard service or characteristic described by the Bluetooth specification, or a 128-bit UUID is a custom service that is vendor specific). The following table illustrates services and characteristics supported by the token handler in an example.

TABLE 1
Services Provided By Token Handler

| | |
|---|---|
| 1800 | GAP Service |
| 2A00 | Device Name |
| 2A01 | Appearance (0 = Unknown) |
| 180A | Device Information Service |
| 2A29 | Manufacturer Name String (Clancy Systems) |
| 2A24 | Model Number String (Clear Token Meter) |
| 2A27 | Hardware Revision String (B) |
| 2A26 | Firmware Revision String (001.003.000.110) |
| 2A28 | Software Revision String (1.31) |
| c9cab9b8-3abf-4043-a5af- | Token Handler Service |
| 9ad00c6074d5 | |
| 0f314942-e257-46a9-a8c8- | ID (currently the 5 character ID on |
| 4c8ecee2cf2b | label, e.g. AAA01) |
| d5dee9b5-456f-4baa-ad5c- | Command |
| a3f14fd2653c | |
| 2902 | Client Characteristic Configuration |
| | (for Command) |
| d5dee9b6-456f-4baa-ad5c- | Beacon Data (Data1) |
| a3f14fd2653d | |

In the table above, three services provided by the token handler are shown in boldface font. Below each service are the characteristics for each service. The characteristics can be read or written to obtain the values. A handle is assigned to each characteristic. There are routines used to determine the handle based on UUID.

In this example, a GAP service has two characteristics. Device name is currently the ID of the Clear Token Device. The Appearance always reads zero (‘unknown’) because the CTD doesn't fall into a pre-defined category of Heart Rate Monitor, Phone, etc.

Some devices (e.g., APPLE™ devices) require that a Device Information Service be provided on each Bluetooth device. The characteristics are self-explanatory.

The Token Handler Service has three characteristics and one Client Characteristic Configuration. The ID is read only and is the ID that is on the label of the meter. The command characteristic can be written and a return code can be read. Before the command characteristic can be used, a value of 0001 is written to the Client Characteristic Configuration. Some Bluetooth stacks do this automatically. Also, some clients may need to send the value as 0100 instead of 0001. Other examples are also contemplated.

Commands and data can now be exchanged with the token handler. Commands are sent to the token handler by writing up to 20 bytes to the Command characteristic handle. Data is received back through the same handle with “notification”.

After communication, the connection is disconnected. The token handler finishes carrying out any tasks, then goes back to sleep. This strategy helps to minimize connection time to the token handler device to conserve battery power.

In an example, the commands and data are in arrays of bytes, with values from 0x00 to 0xFF. The number of bytes sent or received through the FIFO handle is 20 or less at a time. All commands to the CTD begin with a 0x40 (@). The next byte in the array is the number of remaining bytes in the command. In an example, the general format of a command is @ N C P P I I T T, where:
Q=0x40
N=Number of bytes to follow
C=Command code (1 byte)
P=Parameters for the command (number of bytes varies with each command)
I=Index of the validating token (2 bytes, most significant first)
T=validating token (2 bytes, most significant first)

To make the process even more secure, the code can be sent from the user's mobile device as a two part message, wherein part one is a gatekeeper command or message including a unique code and informing the token handler at the laundry machine that part two is following, and then another unique code is sent as part two as an activating command or message. This technique implements two codes for each transaction.

In this example, all replies from the CTD begin with a 0x52. The next byte in the array is the remaining number of bytes in the reply. In an example, the general format of a reply is: R N S, where:

R=0x52

N=number of bytes to follow

S=status (0x01 if command was successful or 0x00 if there was an error)

Validating tokens may also be implemented with the commands. For example, there may be 65536 index positions (0-65535), with each index containing a token with a value from 1-65535. Once a token is used, it is zeroed to prevent re-use and thus reduce fraud.

If an incorrect index/token combination is received, the device responds with a status of 0x00, and not respond to further commands until some time has passed.

In FIG. 3, the following abbreviations are used:

@=0x40—Start of the command

N=Number of bytes to follow

C=Command Code

P=Time (used in Closure & Backlight)

I=Index Value

T=Token Value

H=Hours

M=Minutes

S=Seconds

R=Reset (00=No Reset—01=Reset)

Command 310 is an example Contact Closure Command. This command closes the relay contact for the specified length of time. The length of time the contact remain dosed is the number of 3.90625 millisecond units ( 1/256 of a second) specified with 2 bytes. For example, to close the contact for 1 second, a value of 0x0100 is used; to close the contact for a half second, a value of 0x0080 is used. A value of less than 0x0034 (200 mS) should not be used for this example. @N C P P I I T T, where:
@=0x40
N=0x07, number of bytes to follow
C=0x02
P=length of time for contact closure, MSB first, range 0x0034-0xFFFF I=index of validating token, MSB first
T=validating token, MSB first

Reply: R N S R=0x52, where:
N=0x01, number of bytes to follow
S=0x01 if command and token were successful, 0x00 if index/token was not valid or some other error.

Other commands (not shown in FIG. 3), include by way of illustration, an Enable Beacon Command (0x05). This command enables the token handler to alternate advertising between any of several supported beacon formats. For example, with the uriBeacon, the final 18 bytes of the advertisement data are the encoded URL including prefix byte. This data is written to the GATT attribute database (Beacon Data, see table above) prior to sending the command. In another example, with the iBeacon, 20 bytes of the advertisement data are the UUID and the “major” and “minor” fields. This data is written to the GATT attribute database (Beacon Data, see table above) prior to sending the command.

The rate at which advertising packets are sent doubles when the beacon function is enabled, thus impacting battery life. @N C B I I T T, where:
@=0x40
N=0x06, number of bytes to follow C=0x05
B=0: no beacon, 1: uriBeacon, 2: Apple iBeacon I=index of validating token, MSB first T=validating token, MSB first
Reply: R N S R=0x52 N=0x01
S=0x01 if command and token were successful, 0x00 if index/token was not valid or some other error.

In another example, a Change Transmit Power Command (0x06) changes the transmit power of the CTD. In an example, there are three power levels: low, medium, and high. The default transmit power level after cycling the device power is medium. N C P I I T T, where:
@=0x40
N=0x06, number of bytes to follow C=0x05
P=0: Low, 1: Medium (default), 2: max I=index of validating token, MSB
first T=validating token,
MSB first
Reply: R N S R=0x52 N=0x01
S=0x01 if command and token were successful, 0x00 if index/token was not
valid or some other error.

In another example, a Contact Pulse Command (0x08) momentarily closes (pulses) the relay contact, a specified number of times, for a specified length of time, with a specified spacing between pulses. This can be implemented to mimic coins passing through a coin acceptor in vending applications. @N C P D S I I T T, where:
@=0x40
N=0x08, number of bytes to follow C=0x08
P=Number of pulses, 0-255 (0x00-0xFF)
D=Pulse duration, 1=200 mS, 2=500 mS S=Time between pulses, 1=200 mS, 2=500 mS, 3=one second.
I=index of validating token, MSB first T=validating token, MSB first
Reply: R N S R=0x52
N=0x01, number of bytes to follow
S=0x01 if command and token were successful, 0x00 if index/token was not valid or some other error.

The above example commands are provided for purposes of illustration, but are not intended to be limiting. Still other commands are contemplated as being within the scope of the disclosure herein, as will be readily appreciated by those having ordinary skill in the art after becoming familiar with the teachings herein.

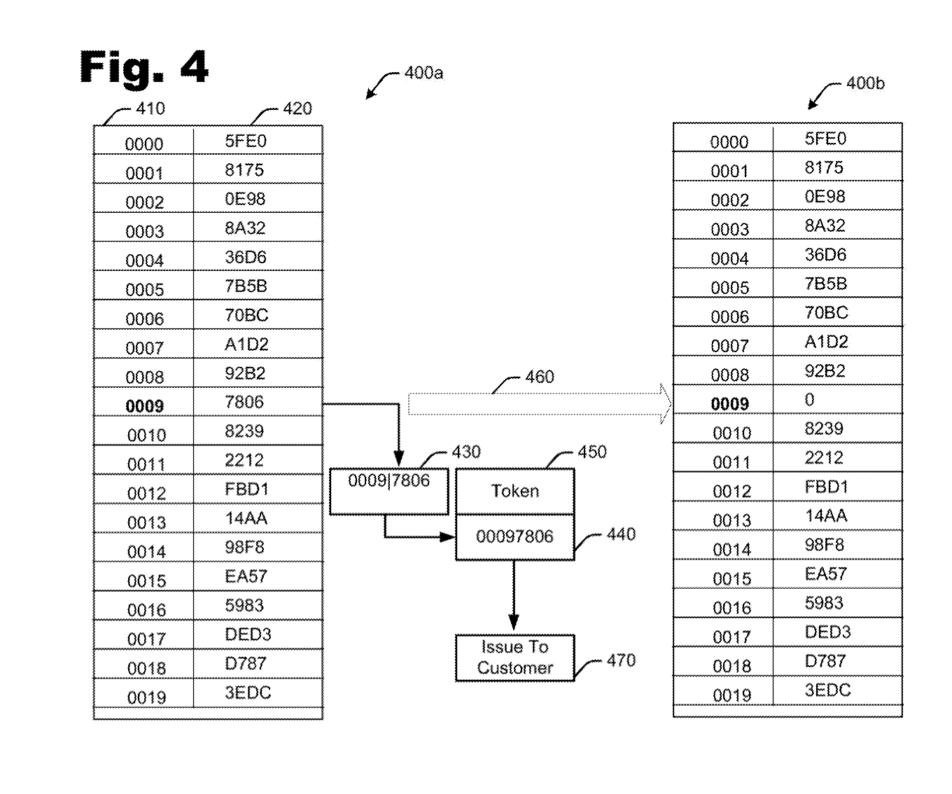

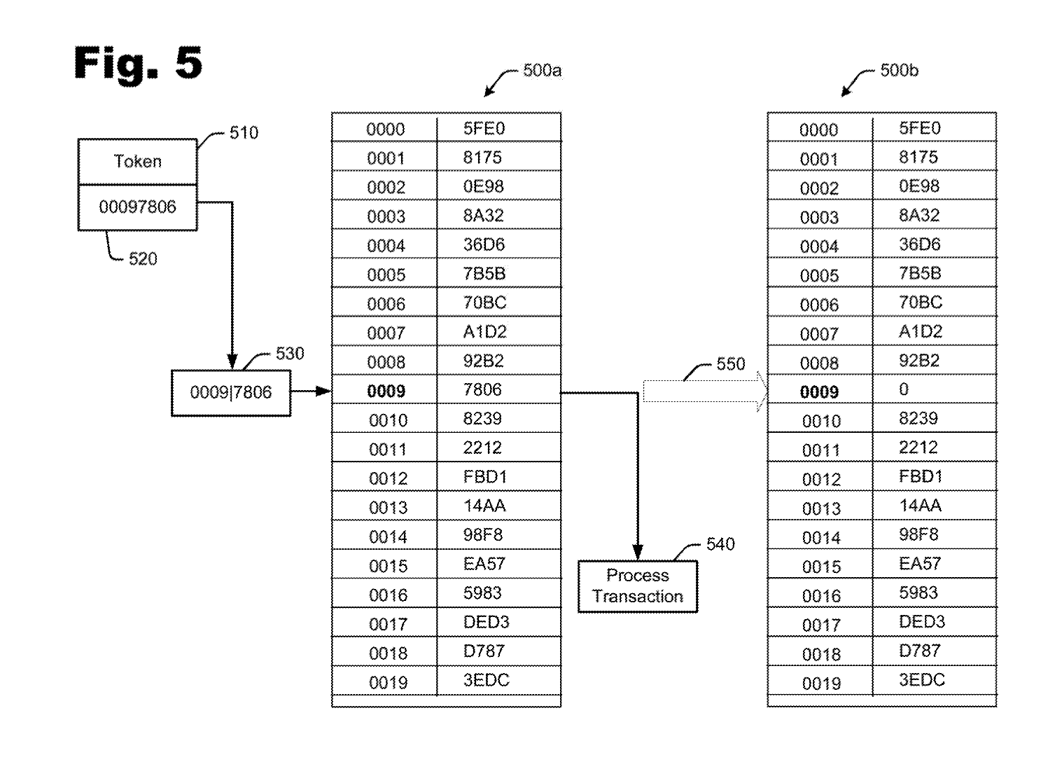

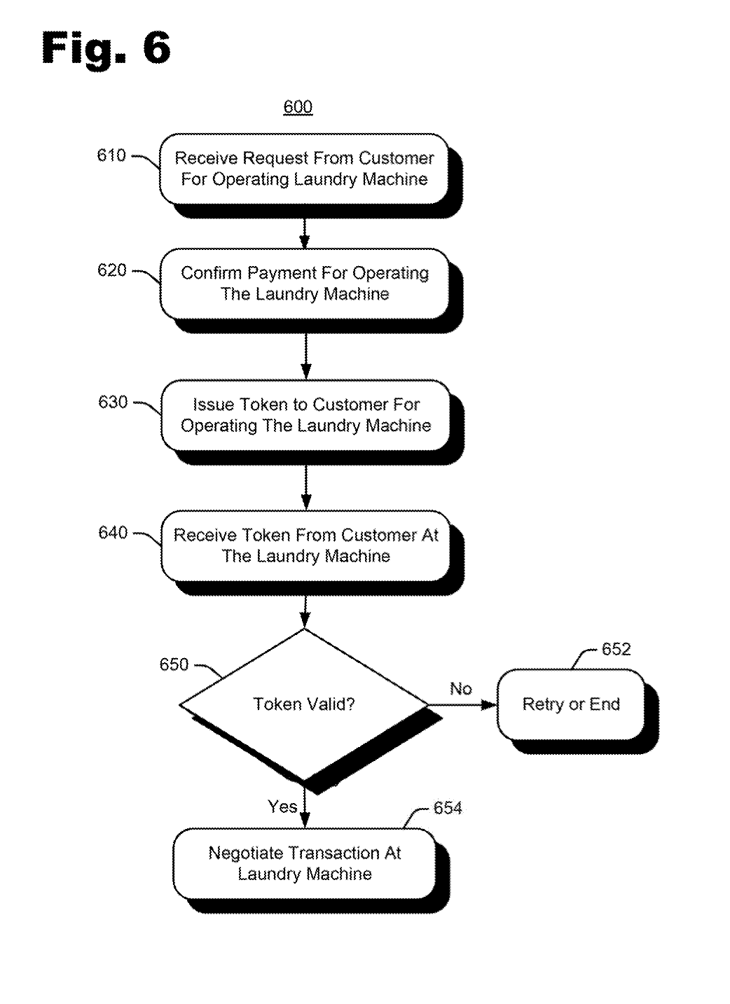

FIG. 4 illustrates an example coding scheme to build a token at a token provider. FIG. 6 illustrates an example coding scheme to validate the token illustrated in FIG. 4, and process a transaction by a token handler at the laundry machine. The tables 400a-b in FIG. 4 and tables 500a-b in FIG. 5 illustrate a code sample (the first 20 entries of 65,536 entries are shown). The first column represents an index (1 through the number of entries), and the second column represents the corresponding code for the index entry. The codes shown in FIG. 4 may be stored at the token provider (e.g., token provider 110 shown in FIG. 1B) and used to generate the token. These same codes (shown in FIG. 5) may also be written to the token handler at the laundry machine by “injecting” the codes in hardware stored in or associated with the token handler at the laundry machine. Each token handler includes its own set of unique codes in an indexed array, stored in memory internal to the token handler at the laundry machine.

During set up, the token handler may be read (e.g., for device ID or location number, and a corresponding code). The codes may be compared to a database record stored by the token provider. If there is a match, then the token handler has been property set up, and is ready for use by the customer.

During use, the user may open a phone app and select the location or other ID of the laundry machine. The location or other ID of the laundry machine may be transmitted by nearby mobile devices (e.g., using Bluetooth or other communications protocol), or the user may manually enter the location or other ID. A request is generated on the user's mobile device, including the location and/or other information for the laundry machine. Additional Information may also be included in the request (e.g., operating time for a laundry machine, ID number for the laundry machine). The user may also select a payment processor (e.g., a bank, credit card processor, PayPal®, etc.) to be included in the request. The user may be prompted to use the last payment processor used or enter a new payment processor.

The request is sent to the token provider to authorize payment. The payment processor may charge the user's account and return “Approved” or “Declined” to the token provider. The digital payment service may notify the user (e.g., if payment was declined). But the token provider never receives personal or financial information or credit card information of the user.

If the payment is approved, then the token provider may build a token for the user to deliver to the token handler at the laundry machine. In an example, the token may include a location code, duration or activation code, security code (FIG. 4), and optionally an advertisement or other information for the user to view. For example, the token provider may select transaction index (e.g., index location 0009) from the index column 410 and read a corresponding transaction code (e.g., hex 7806 representing decimal 30726) from the code column 420, as illustrated by the numbers 430 in FIG. 4. It is noted that any suitable system (e.g., alpha-numeric) may be used, and is not limited to a numbering system.

In this example, the numbers are in hexadecimal and added (e.g., as packet 440) to the token 450. The table 400a may be updated as illustrated by arrow 460 and shown as updated table 400b, wherein the code at index location 0009 is set to “0”. The token 450 may then be issued to the customer as illustrated by block 460.

The user may then relay the token 510 including the hexadecimal 520 to the token handler, as illustrated in FIG. 5. The token handler receives the token, and validates the transaction code in the token (FIG. 5), for example by reading the token packet 520 and comparing the index and hex code 530 with the corresponding index location 0009 of the device index. If the device code at index location 0009 in table 500a matches the transaction code in the token 510, the token handler may negotiate or process the transaction 540 by executing a device command (e.g., activate the laundry machine).

The token handler may also update/modify the table 500a, as illustrated by arrow 550, to indicate that the code has been used (e.g., by setting the code in index 9 to all 0's) as shown by updated table 500b in FIG. 5. As such, the index location 9 cannot be re-used, thereby preventing fraudulent use.

In this example, a small 128K file contains 65,536 unique codes. For a laundry machine being used on average 20 times a day, the original codes are predicted to last about 9½ years. For a busy location being accessed 100 times a day, the original codes are predicted to last about 2 years. In the event that the codes need to be changed or updated, a secure update procedure may be implemented to refresh the codes in the field.

It should be understood that the systems and techniques described above may be modified within the scope of the disclosure herein, and are not limited to any particular implementation. For example, the example code and indexing illustrated in the figures is illustrative and not limiting.

FIG. 6 is a flow chart illustrating example operations 600 which may implement a digital payment method. In example operation 610, a request for a transaction at a laundry machine may be received from a customer by a token provider. The token provider confirms payment for the transaction in operation 620, and then issues a token to the customer in operation 630. In an example, the token has a transaction index and a corresponding transaction code.

In operation 640, the token is received from the customer. For example, the token may be received from the customer's mobile device via a BLUETOOTH™ or other near-field communication protocol with the token handler at the laundry machine. In operation 650, the token handler at the laundry machine confirms validity of the token, e.g., based on the transaction index and the transaction code. If the token is not valid, operations may end with operation 652. In another example, the token handler may issue feedback to the user (e.g., to retry by sending a different token). If the token is valid, the token handler may negotiate the transaction at the laundry machine in operation 654. In an example, the token handler may start, set (or add) an operating time for the customer to use the laundry machine.

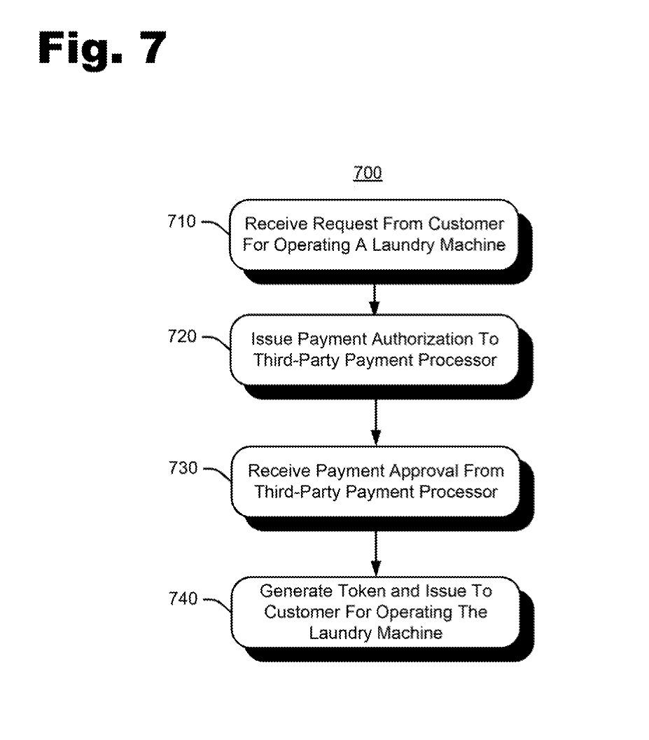

FIG. 7 is a flow chart illustrating example operations 700 of a token provider to implement a digital payment method. In operation 710, the token provider may receive a request for a transaction at a laundry machine from a customer. In an example, the request may include information about the laundry machine (e.g., identifying information). In operation 720, the token provider issues a payment authorization to a third-party payment processor. It is noted that the token provider does not actually receive any payment or other personal or confidential payment information from the customer. This information remains confidential as between the customer and the third party payment processor (e.g., the customer's bank or credit card processor). In operation 730, the token provider receives payment approval from the third-party payment processor.

In operation 740, the token provider generates a token and issues the token to the customer so that the customer can complete the transaction at the laundry machine. In an example, the token includes a hex value representing the transaction code and the transaction index.

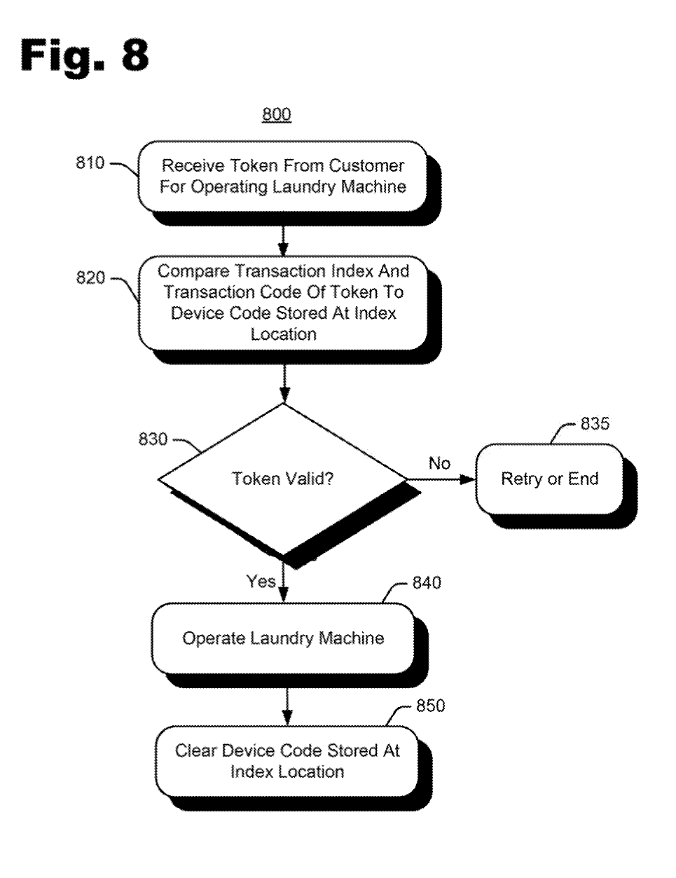

FIG. 8 is a flow chart illustrating example operations 800 of a token handler to implement a digital payment method. In operation 810, the token handler at a laundry machine receives a token from the customer (e.g., the token issued to the customer by the token provider in operation 740). The token handler may receive the token from the customer's mobile device via a BLUETOOTH™ or other near-field communication protocol. In an example, the token includes a hex value representing the transaction code and the transaction index.

In operation 820, the token handler compares the transaction index and transaction code of the token to a device code stored at corresponding index location at the token handler. For example, the token handler may translate the hex value to determine the transaction code and the transaction index, and then compare these to the corresponding device code stored at the associated index location at the token handler.

In operation 830, the token handler determines whether the token is valid. If the token is not valid, operations at the token handler may end with operation 835. In another example, the token handler may issue feedback to the user (e.g., to retry by sending a different token).

If the token is valid, the token handler may negotiate the transaction at operation 840. In an example, the token handler may activate, set (or add) a time duration for the customer to use the laundry machine.

In operation 850, the token handler clears the device code stored at the index location so that the token cannot be reused.

Example operations shown in FIGS. 6-8 are illustrative and not intended to be limiting. The ordering of operations is not limited to the ordering shown in the drawings. Still other operations are also contemplated, as will become readily apparent to those having ordinary skill in the art after becoming familiar with the teachings herein.

It is noted that the examples shown and described herein are provided for purposes of illustration and are not intended to be limiting. Still other examples are also contemplated.

1. A digital payment method for a laundry machine, the method comprising:
receiving a request from a customer for a transaction at the laundry machine;
confirming payment by the customer for the transaction at the laundry machine;
issuing a token to the customer for the transaction at the laundry machine, the token having a transaction index and a transaction code for the laundry machine;
receiving the token from the customer at a token handler for the laundry machine;
confirming validity of the token at the token handler for the laundry machine based on the transaction index and the transaction code for operating the laundry machine; and
negotiating the transaction for the customer by the token handler for the laundry machine.

2. The method of claim 1, further comprising retrieving identifying information for the laundry machine based on the request from the customer.

3. The method of claim 1, wherein confirming payment by the customer for the transaction at the laundry machine comprises:
issuing a payment authorization to a third-party payment processor; and
receiving payment approval from the third-party payment processor.

4. The method of claim 1, wherein confirming validity of the token at the token handler for the laundry machine comprises comparing the transaction index and the transaction code of the token to a device code stored at an index location associated with the laundry machine.

5. The method of claim 4, further comprising clearing the device code at the index location associated with the laundry machine so that the token cannot be reused.

6. The method of claim 1, further comprising executing a device command at the token handler for the laundry machine if the token is valid.

7. The method of claim 1, wherein the token includes a hex value representing the transaction code and the transaction index for operating the laundry machine.

8. A secure payment system for a laundry machine, the system comprising:
a token handler for the laundry machine, the token handler configured to receive a token from the customer for a transaction at the laundry machine, the token handler further configured to confirm validity of the token based on a transaction index and a transaction code of the token for operating the laundry machine;
wherein the token handler is electronically connected to control electronics of the laundry machine, the control electronics operating a motor of the laundry machine in response to a signal received from the token handler after confirming receipt of a valid token.

9. The system of claim 8 further comprising a remote payment module to confirm payment by the customer for operating the laundry machine, and to issue the token to the customer, the token having the transaction index and the transaction code to actuate the motor of the laundry machine.

10. The system of claim 9, wherein the remote payment module receives identifying information of the laundry machine from the request by the customer.

11. The system of claim 9, wherein the remote payment module confirms payment for use of the laundry machine by:
issuing a payment authorization to a third-party payment processor; and
receiving payment approval from the third-party payment processor.

12. The system of claim 11, wherein the remote payment module confirms payment without receiving confidential payment information from the customer.

13. The system of claim 8, wherein the token handler confirms validity of the token by comparing the transaction index and the transaction code of the token to a device code corresponding to an index location associated with the laundry machine.

14. The system of claim 13, wherein the token handler clears the device code at the index location associated with the laundry machine so that the token cannot be reused.

15. The system of claim 14, wherein the device code associated with the laundry machine is refreshed via a secure field procedure.

16. The system of claim 8, wherein the token includes a hex value representing the transaction code and the transaction index for operating the laundry machine.

17. A secure payment system for a laundry machine, the system comprising:
a remote payment processor to confirm payment by a customer for a transaction at the laundry machine, and to issue a token to the customer for the transaction, the token having a transaction index and a transaction code to operate the laundry machine;
an interface module for the laundry machine configured to receive the token from the customer for the transaction;
a token handler having a token processing module to confirm validity of the token based on the transaction index and the transaction code of the token, the token handler issuing a signal to actuate control electronics of the laundry machine in response to a valid token.

18. The system of claim 17, wherein the remote payment processor is configured to issue a payment request to a third-party payment processor, and receive payment approval from the third-party payment processor.

19. The system of claim 17, wherein the payment module confirms validity of the token by comparing the transaction index and the transaction code of the token to a device code stored at an index location associated with the laundry machine.

20. The system of claim 17, wherein the payment module clears the device code stored at the index location associated with the laundry machine after negotiating the transaction so that the token cannot be reused.
